(19) United States
(12) Patent Application Publication
(10) Pub. No.: US 2009/0016721 A1
(43) Pub. Date: Jan. 15, 2009

(54) Method and apparatus for enhanced power diagnostics

(75) Inventors: Michael J. Wurst, Santa Rosa, CA (US); Mark E. Lewis, Yountville, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Petaluma, Inc., Naperville, IL (US)

(21) Appl. No.: 11/827,823

(22) Filed: Jul. 13, 2007

(51) Int. Cl. H04J 14/00

(52) U.S. Cl. 398/67

(57) ABSTRACT

Example embodiments of the invention provide a system for monitoring a battery backup unit (BBU) deployed in a network. The BBU typically communicates in a unidirectional manner with an external device, such as an Optical Network Terminal (ONT), is able to communicate in a bidirectional manner. The useful improvements of communicating in a bidirectional manner include installation integrity, real-time troubleshooting, and software upgrades. Moreover, the BBU is able to monitor an output power or status information of a primary power source, such as an Optical Network Terminal (ONT) Power Supply Unit (OPSU). Specifically, example embodiments allow the BBU to be enabled in an event of a loss of primary power to the ONT. The BBU may communicate in a bidirectional manner between the BBU and the device external from the BBU to receive status request signals and provide information responsive thereto about the BBU, including information about the battery.

### BACKGROUND OF THE INVENTION

Some network devices, such as Optical Network Terminals (ONTs), are equipped with batteries and Battery Backup Units (BBUS) to support continued service in an event of a primary power interruption. The BBU is a device that manages the power feed to an ONT. Power can come from a commercial source, such as a home alternating current (AC) outlet or the battery. Batteries have limited service and shelf life, so when batteries expire, customers are urged to perform maintenance by returning, recycling or disposing them and installing a new battery. The manufacturer(s) of network devices, batteries or battery backup units are generally not burdened with maintenance after field deployment, but the maintenance impacts the customers, such as service providers and the end users (e.g., subscribers) of the service providers.

BBUs communicate in a unidirectional manner with an ONT to send information to the ONT for transmitting to a technician. Moreover, it is difficult to verify installation integrity of a BBU telemetry cable between the BBU and the ONT.

### SUMMARY OF THE INVENTION

A method and corresponding apparatus for monitoring a battery backup unit with at least one battery in accordance with example embodiments of the invention, are provided. An example embodiment includes enabling a battery backup unit and communicating in a bidirectional manner between the battery backup unit and a device external from the battery backup unit to receive status request signals and provide information responsive thereto about the battery backup unit, including information about the at least one battery.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating example embodiments of the invention.

FIG. 1 is a network diagram of a Passive Optical Network (PON) employing example embodiments of the invention;

FIGS. 2A and 2B are block diagrams of a Battery Backup Unit (BBU) and system in accordance with example embodiments of the invention;

FIG. 3 is a flow diagram performed in accordance with an example embodiment of the invention;

FIGS. 4A and 4B are block diagrams of Battery Backup Units (BBUs) in accordance with example embodiments of the invention;

FIGS. 5A and 5B are block diagrams of Battery Backup Units (BBUs) in accordance with yet other example embodiments of the invention;

FIG. 6 is a flow diagram performed in accordance with another example embodiment of the invention; and

FIG. 7 is a block diagram of an Integrated Power Supply Unit (IPSU) in accordance with yet another example embodiment of the invention.

### DETAILED DESCRIPTION OF THE INVENTION

A description of example embodiments of the invention follows.

Current Passive Optical Network (PON) (e.g., broadband PONs (BPON), gigabit PONs (GPON), and other derivatives) architecture may employ hardware (e.g., Battery Backup Unit (BBU) and Optical Network Terminal (ONT) Power Supply Unit (OPSU) to manage and regulate power to the fiber terminating equipment (e.g., ONT) at the customer premise. An OPSU may also be referred to as a Serial ONT Power Supply (SOPS) as is known in the art. For the sake of convenience and readability, the term OPSU is used throughout the specification, but one skilled in the art will readily recognize that principles of the invention are also applicable to the SOPS. Architecture implementations derive primary power from the residential utility power grid and can seamlessly transition to a battery when utility power is lost.

It would be useful for manufacturers of network devices and BBUs to consider scenarios that can improve the products such that manufacturers, service providers, and end users can easily manage them. A battery backup unit (BBU) may also be referred to as a serial battery backup power supply (SBBPS) as is known in the art. For the sake of convenience and readability, the term BBU is used throughout the specification, but one skilled in the art will readily recognize that principles of the invention are also applicable to the SBBPS. Example embodiments of the invention may include one or more of these useful improvements: bidirectional communications regarding the state of the power equipment (e.g., OPSU, BBU, and battery), installation integrity, real-time troubleshooting, and software upgrades. Currently, unidirectional communications between the BBU and the ONT cannot provide the state of the power equipment (e.g., OPSU, BBU, and battery), installation integrity, real-time troubleshooting, and software upgrades. For example, if a technician wants to learn more about the state of the power equipment (e.g., OPSU, BBU, and battery), he/she may have to go to the end user's house to take measurements of the power equipment.

An example embodiment of the invention provides for bidirectional communications with a BBU. The bidirectional communications may be used to monitor, for example, status of the BBU or remaining power that can be provided by the BBU. The BBU may include at least one battery, a bidirectional communications bus, and a control unit. The control unit may be coupled to the at least one battery and the bidirectional bus. The control unit may communicate in a bidirectional manner with a device external from the battery backup unit, such as an ONT, which is also coupled to the bidirectional communications bus to receive status request signals and provide information responsive thereto about the battery backup unit. The information about the battery backup unit includes information about the at least one battery, temperature, current, and voltage. The control unit may include at least one line coupled to the control unit to receive the status request signals and provide bidirectional communications responsive thereto with the device external from the battery backup unit in addition to bidirectional communications via the bidirectional communications bus.

The BBU may include a battery recharger to recharge the at least one battery when a primary power source (e.g., local AC power) is ON. The BBU may further include at least one interface port coupled to the communications bus to provide bidirectional communications with the device external from the battery backup unit. The at least one interface port may be a parallel, serial, or wireless interface configured to receive the status request signals and provide information responsive thereto with another device at the battery backup unit other than the device configured to receive backup power from the battery backup unit.

The battery backup unit may further include a primary power monitoring unit coupled to a primary power source to monitor power or status information of the primary power source. The primary power source may be an Optical Network Terminal (ONT) Power Supply Unit (OPSU). The primary power monitoring unit may include an alternating current (AC) monitoring circuit to monitor AC input voltage or current and provide information to the device external from the battery backup unit about the AC input voltage or current. The primary power monitoring unit may further include a direct current (DC) monitoring circuit to monitor DC output voltage or current and provide information to the device external from the battery backup unit about the DC input voltage or current.

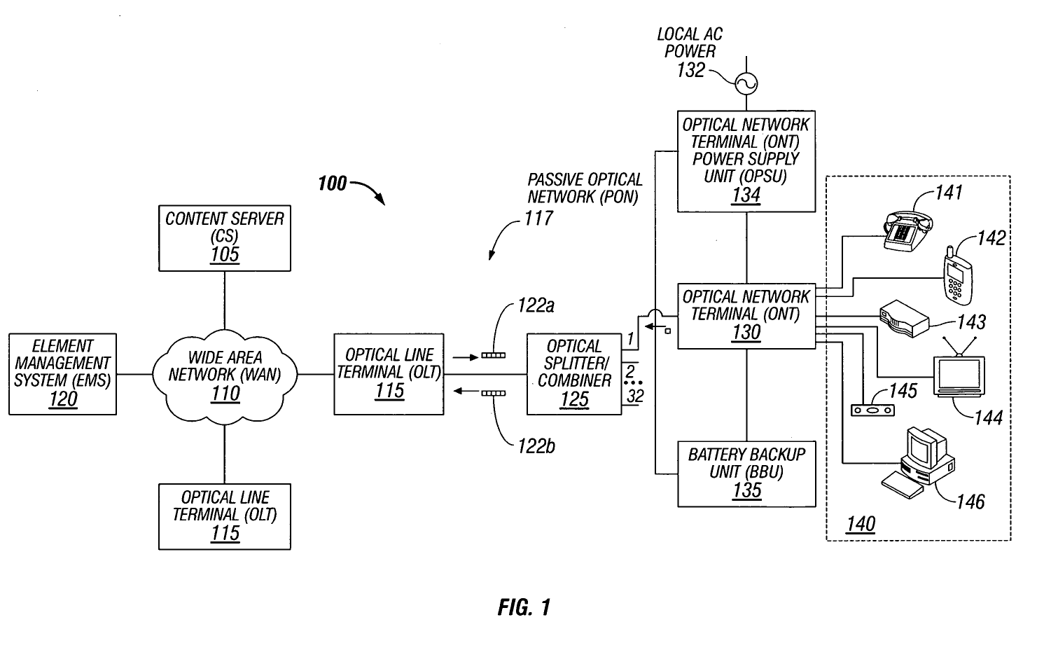

FIG. 1 is a block diagram of an example network 100 in which example embodiments of the invention may be employed. The network 100 includes a Wide Area Network (WAN) 110 and a Passive Optical Network (PON) 117. The WAN 110 may be a network, such as the Internet, and the PON 117 is typically a more localized network in which optical signals, used to transmit information, traverse passive optical elements, such as splitters and combiners 125, to be communicated between network nodes. The PON 117 may be deployed for fiber-to-the-premise (FTTP), fiber-to-the-curb (FTTC), fiber-to-the-node (FTTN), and other fiber-to-the-X (FTTX) applications. The PON 117 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 117.

The example network 100 of FIG. 1 includes one or more Optical Line Terminals (OLTs) 115, an Element Management System (EMS) 120, and a Content Server (CS) 105, all connected, generally, by the WAN 110. In the example network 100, each OLT 115 transmits/receives information in the form of a frame of packets 122a, 122b embodied on optical signals to/from an optical splitter/combiner 125 to communicate with one or more (for example, up to thirty-two) Optical Network Terminals (ONTs) 130. Each ONT 130 receives primary power by local alternating current (AC) power 132 at respective points of installation. The ONTs 130 provide connectivity to customer premises equipment 140 that may include standard telephones 141 (e.g., Public Switched Telephone Network (PSTN) and cellular network equipment), Internet Protocol (IP) telephones 142, network routers 143, video devices (e.g., televisions 144 and digital cable decoders 145), computer terminals 146, digital subscriber line connections, cable modems, wireless access devices, as well as any other conventional, newly developed, or later developed devices that may be supported by the ONT 130.

The ONTs 130 may be equipped with batteries or battery backup units (BBUs) 135, interchangeably referred to herein as a BBU 135. The BBU 135 may be an uninterruptible power supply unit. In an event an ONT 130 equipped with a BBU 135 experiences an interruption in primary power (e.g., local AC power/primary power source 132), the ONT 130 may enable the BBU 135 or otherwise accept receipt of power from the BBU 135 to maintain services until the primary power source 132 is restored or the BBU 135 is drained of stored energy. On legacy products, the ONT 130 may regulate power between the BBU 135 and an Optical Network Terminal (ONT) Power Supply Unit (OPSU) 134. On newer designs, the BBU 135 may provide other operations, such as regulating the power feed.

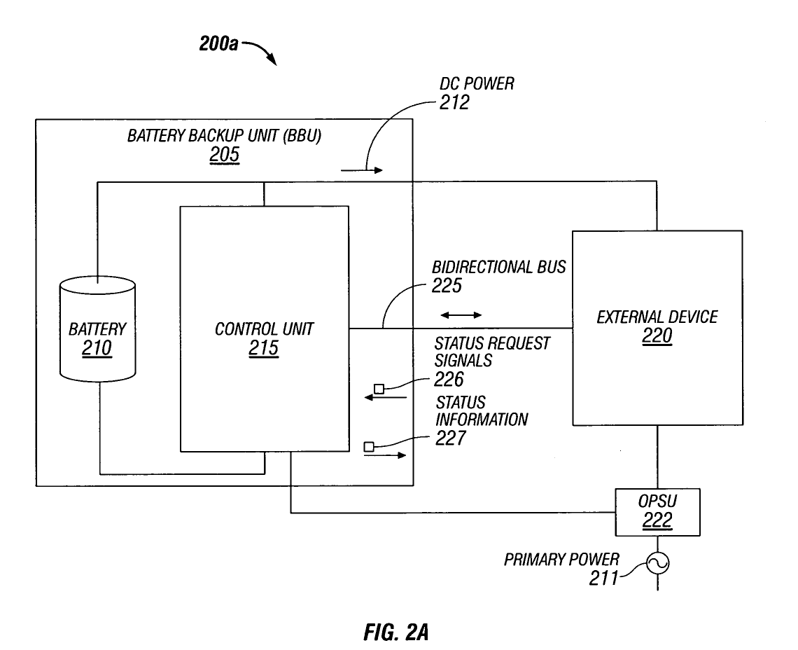

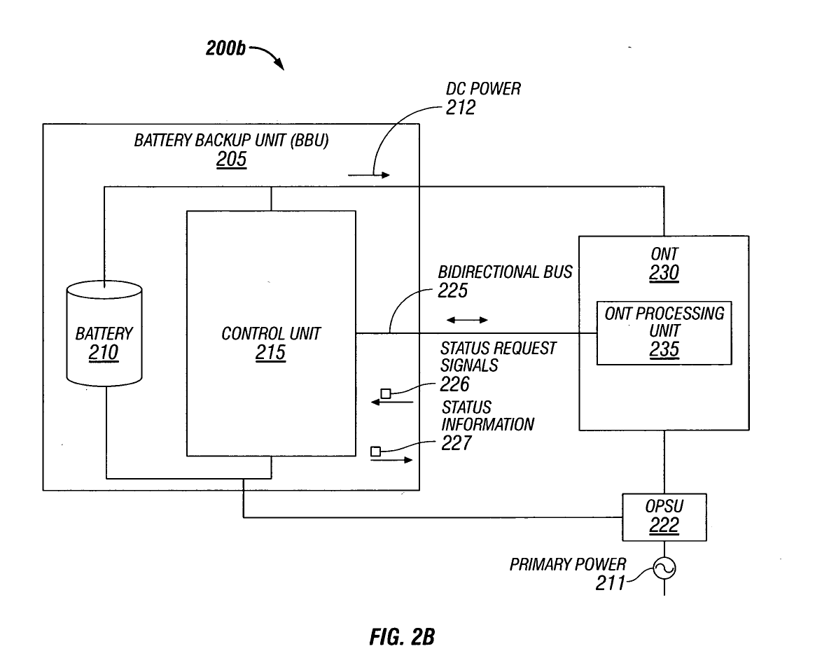

FIGS. 2A and 2B are high level network diagrams 200a, 200b according to example embodiments of the invention. In FIG. 2A, the network diagram 200a includes an external device 220 in communication with a Battery Backup Unit (BBU) 205 via a bidirectional communications bus 225. The external device 220 may receive DC power 212, in this example, from the BBU 205. The BBU 205 communicates in a bidirectional manner with the external device 220. The BBU 205 provides backup power to the external device 220 in an event of a loss in primary power from a primary power source 211 via an Optical Network Terminal (ONT) Power Supply Unit (OPSU) 222 to the external device 220 until the primary power is restored. The external device 220 may be an ONT. A control unit 215 may communicate in a bidirectional manner with the external device 220 via the bidirectional communications bus 225. The control unit 215 may receive status request signals 226 and provide status information 227 responsive thereto about the battery backup unit 205, including information about the at least one battery 210. The information about the at least one battery 210 may include temperature, current, or voltage. The information about the at least one battery 210 may also include battery test logs.

FIG. 2B is another high level network diagram 200b of an example network including an ONT 230 connected to a BBU 205 via a bidirectional communications bus 225. The BBU 205 provides backup power 212 to the ONT 230, which includes an ONT processing unit 235, by enabling transfer of DC power (i.e., backup power 212) to the ONT 230, optionally via the Optical Network Terminal (ONT) Power Supply Unit (OPSU) 222, in an event of a loss in primary power 211 to the ONT 230 until the primary power 211 is restored.

As described above in reference to FIG. 2A, the control unit 215 may receive status request signals 226 and provide status information 227 responsive thereto about the BBU 205, including information about the at least one battery 210. The information about the at least one battery 210 may include for example temperature, current, or voltage. Information about the average ambient temperature, for example, may be used to perform failure analysis. For example, a rapid rise in temperature may indicate a particular type of failure. The information about the at least one battery 210 may help to predict when it may fail rather than having to wait for a “replace battery” alarm. For example, when the BBU 205 runs a battery test, the test may indicate that the battery is nearing an end of its useful life when its capacity is at 30%, which may be a threshold for failing. However, if the battery passes the battery test, a technician may not know how close it is to that 70% capacity. By monitoring the battery capacity, the control unit 215 may predict when the at least one battery 210 may fail and alert the ONT processing unit 235, which may, in turn, provide an electronic message (not shown) to a service provider or an audible or visible alarm to an end user.

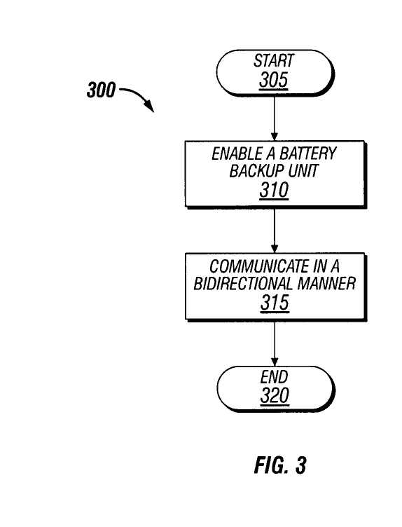

FIG. 3 is an example flow diagram 300 performed in accordance with an example embodiment of the invention. The flow diagram 300 starts (305), and a BBU is enabled (310) in an event of a loss of primary power to an external device, such as an ONT. The primary power may be, for example, a power connection to a source (e.g., a wall outlet) providing power in the form of alternating current supplied to the external device by a power company. The BBU communicates in a bidirectional manner (315) with the device external from the BBU to receive status request signals and provide information responsive thereto about the BBU, including information about the backup power source. The flow diagram 300 then ends (320).

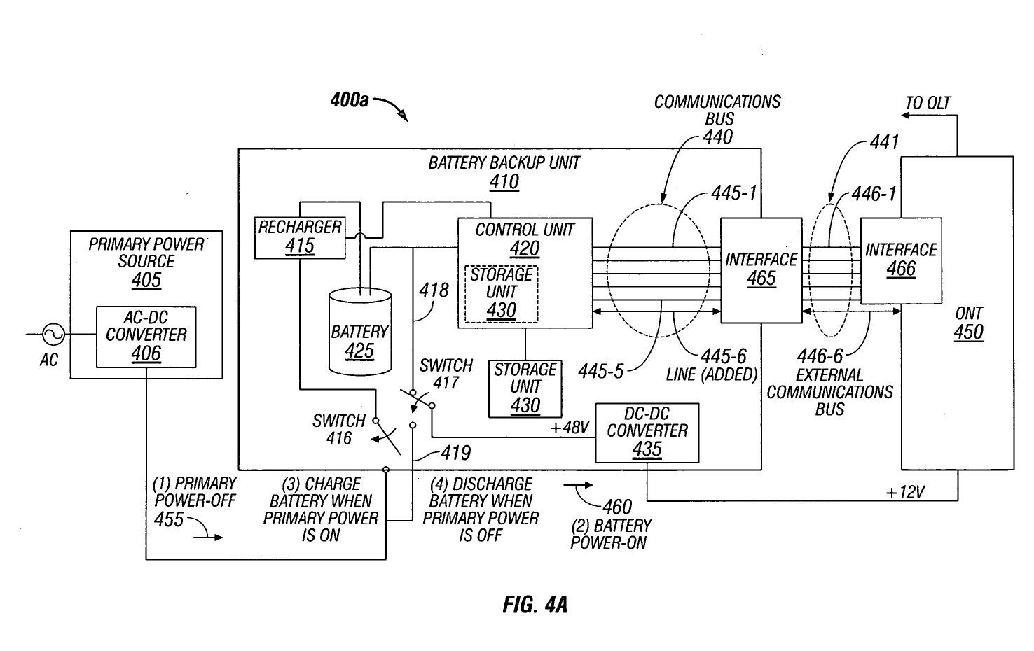

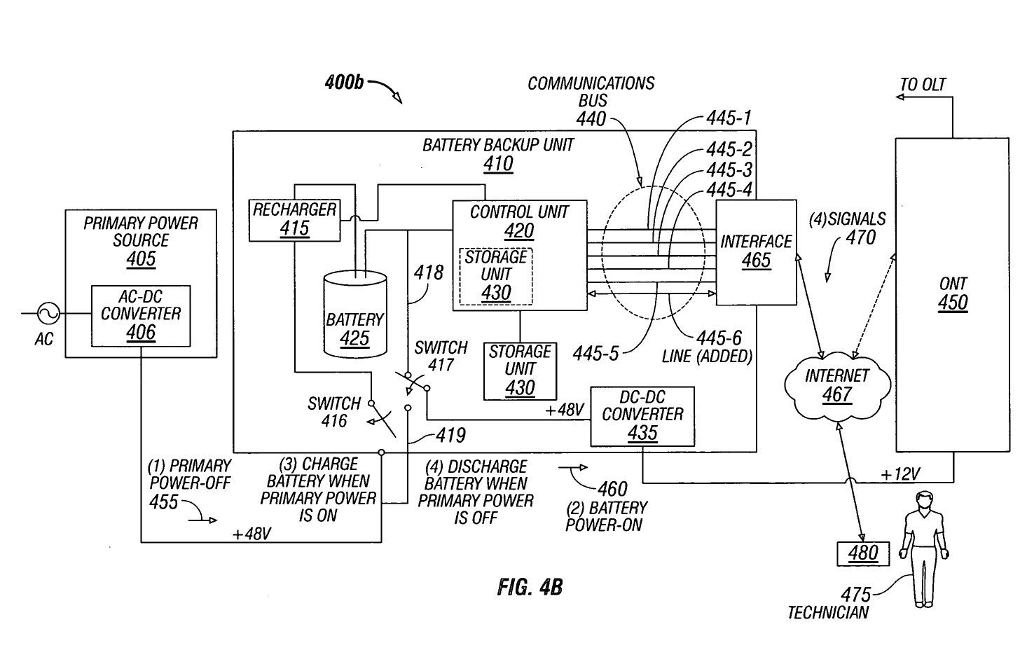

FIGS. 4A and 4B are block diagrams of example Battery Backup Units (BBUs) 400a, 400b according to example embodiments of the invention. In FIG. 4A, a BBU 410 includes a control unit 420 having a communications bus 440. The communications bus 440 may include at least one line 445 coupled to the control unit 420 to receive status request signals and provide bidirectional communications responsive thereto with an external device (e.g., ONT 450) external from the BBU 410, either physically or logically, in addition to bidirectional communications via the bidirectional communications bus 440. Each BBU 410 may include a control unit 420 for self test, ONT voltage regulation, battery test, and battery charging management. Typically, access to the control unit 420 is often difficult and is limited to manufacturing and laboratory diagnostic testing. Access to the control unit 420 when the BBU is deployed in the field provides utility to the customer in installation integrity, real-time trouble shooting, and software upgrades.

The following discussion of control unit 420 is made with reference to a particular example embodiment. However, one skilled in the art will understand that the invention is not limited to this particular example embodiment. The control unit 420 may be a central processing unit (e.g., STMicroelectronics® part number ST 72F324K2T6) that has a full 8-bit architecture and contains six internal registers allowing efficient 8-bit data manipulation. One way of providing access to the control unit 420 to provide bidirectional communications is to add a sixth trace or wire 445-6 to a five trace communications bus 440 that is currently used in installation. In current configurations, four of the six traces or wires 445-1 . . . 4 are used for unidirectional telemetry signals (i.e., on battery, low battery, failed battery, and missing battery). A fifth trace or wire 445-5 carries a ground reference. Each signal is carried by a separate trace or wire 445-1 . . . 5 from the BBU 410 to the ONT 450. These unidirectional telemetry signals are managed (e.g., raised and cleared) by the BBU 410. The provisioning of alarm signal thresholds and algorithmic models for managing these signals are predefined by factory setting(s). Currently, the sixth trace or wire 445-6 is non-existent. The sixth trace or wire 445-6 is unneeded in previous implementations of BBU's 410 because five traces or wires 445-1 . . . 5 are all that the control unit 420 uses or needs to transmit its unidirectional data.

An external cable 441 with wires 446-1 . . . 5 previously existed to carry unidirectional communications is connected between an interface 465 at the BBU 410 and an interface 466 at the ONT 450. A sixth wire 446-6 may be added to support an example embodiment of the invention to carry bidirectional communications. The sixth wire 446-6 may connect the interface 465 of the BBU 410 and the interface 466 of the ONT 450 to support bidirectional communications. In past implementations of BBUs, the control unit 420 is programmed to communicate unidirectionally since higher level functions that can be achieved through bidirectional communications have been considered unnecessary; changes with batteries are so slow paced that periodic status reports from the control unit 420 have been more than adequate for monitoring purposes. However, unexpected results have been found through use of bidirectional communications, such as realizing value of on-demand learning of a state of the power equipment (e.g., OPSU, BBU, and battery), immediate determination of installation integrity, real-time troubleshooting, and downloading and testing software upgrades. The sixth wire 446-6 therefore may be implemented for bidirectional communications. Another example of providing access to the control unit for bidirectional communications is to replace the sixth trace or wire 445-6 with two wires (not shown) connected to a bidirectional serial interface (not shown).

A Joint Test Action Group (JTAG) header (not shown) may be used to program the control unit 420 to support bidirectional communications. Further, instead of the sixth trace or wire 445-6 going from the interface 465 to the control unit 420, the sixth trace or wire 445-6 may be connected to a pin of the JTAG header after programming, and a pin of the control unit 420 may then be used to support the bidirectional communications via the JTAG header and the sixth trace or wire 445-6 with the ONT 450.

Bidirectional communications are useful in many ways. The following examples of the usefulness of bidirectional communications are intended as illustrations and are not intended to be exclusive or limiting in anyway. A first way bidirectional communications can be used is to verify installation integrity. Current installation verification mechanisms rely on a technician to inspect visually the installation of hardware and telemetry harnesses between the BBU 410 and the ONT 450. Visual inspection can be challenging and time consuming for the technician since the BBUs 410 and ONTs 450 are typically located in different parts of a customer's home. For example, there are scenarios in which the BBUs 410 are installed in a garage and the ONTs 450 are installed outside of a house. In addition, the bidirectional communications bus/wiring harnesses 441 may be built at the site. A technician for example, may reverse the wiring harnesses 441 or accidentally crimp the harnesses 441. Therefore, wire orientations and improper connector termination are known to be installation issues. The bidirectional communications may allow the technician (either at the customer's site or remotely via a management system) to initiate a telemetry self test. The self test instructs the BBU 410 via the control unit 420 to generate momentarily and clear each telemetry alarm in a pre-defined sequence. The test may be designed to pass if each signal is raised and cleared in the order expected. Failure of the test may indicate a possible telemetry wiring issue.

A second way that bidirectional communications may be useful is in support of real-time troubleshooting. Current troubleshooting methods and procedures are limited to evaluating current and historical alarms as discussed above. Through use of the bidirectional communications, however, a technician may initiate diagnostic tests, such as “battery test,” on demand. The bidirectional communications may also be used to allow the technician to recover current and historical BBU 410 logs on demand from a storage unit 430 coupled to the control unit 420 of the BBU 410 or integrated in the control unit 420. These logs may include information on recent battery tests and/or input and output voltage or current measurements. The information may be used to quantify the battery 425 capacity, instead of a simple pass/fail test. The information may also include quantifying the battery 425 temperature.

Moreover, a telecommunications company (e.g., service provider responsible for the ONT 450) may use the information about the battery 425 to alert the end user to replace the battery 425. The logs may be archived for evidence available for potential litigation if the end user does not replace the battery 425 and a catastrophic event occurs, allegedly caused by an old or defective battery. The logs may also be used to predict when the battery 425 may fail rather than having to wait for the actual failure. This is useful at an onset of inclement weather (e.g., winter) when replacing the battery 425 may be difficult. The ONT 450 may be programmed to pull and archive the logs periodically from the BBU 410 for future analysis.

A third way that bidirectional communications may be useful is for software upgrades. Typically, provisioning settings in the BBU 410 is done at a manufacturer's facility. Any modification of these settings once the equipment is deployed to the field is generally time consuming and expensive. For example, a technician may be dispatched to the customer site to remove and return the BBU 410 to the manufacturer for modification. Another example may require the end user to remove and mail the BBU 410 back to the manufacturer. Bidirectional communications may allow a technician to download software upgrades to the BBU 410 remotely without the need to remove the BBU 410 and mail it back to the factory.

A fourth way that bidirectional communications may be useful is to aid in forcing the BBU 410 to reset. Instead of a service provider calling the end user to ask him/her to remove the battery power, the BBU 410 may allow a technician to remotely initiate a reset of the BBU 410.

Continuing to FIG. 4A, when a primary power source 405 is OFF (i.e., primary power 455 is OFF), battery power is ON 460 to supply electrical energy to the ONT 450. The primary power source 405 may include an AC-DC converter 406 to convert AC power to a DC power voltage, such as +48 VDC. The BBU 410 may include a recharger 415 to recharge the battery 425 when the primary power 455 is ON. When the primary power 455 is ON, a switch 416 may be in a closed position to recharge the battery 425 and a switch 417 makes contact with a trace 419 to supply power to the ONT 450. Conversely, when the primary power 455 is OFF, the switch 416 is in an open position and therefore is not providing an electrical connection to recharge the battery 425. The switch 417 connects to a trace 418 to supply battery power 460 to the ONT 450. The BBU 410 includes a control unit 420 that controls the operation of the BBU 410, including the switches 417, 418. Instructions operable to cause the control unit 420 to control the operation of the BBU 410 can be stored in a storage unit 430.

The battery 425 may be a nickel metal hydride, nickel-cadmium, lithium-ion, or lithium polymer cell, as well as any other conventional, newly developed, or later developed rechargeable battery. The BBU 410 may also include a DC-DC converter 435 to convert the +48V to +12V for the ONT 450. Although FIG. 4A shows the DC-DC converter 435 in the BBU 410, the DC-DC converter 435 may also be integrated into the ONT 450. Also, although described as producing positive DC voltages, the converters 406 and 435 may produce negative voltages in other example embodiments.

FIG. 4B is a schematic diagram similar to FIG. 4A but does not include the external cable 441 with wires 446-1 . . . 5 coupled to the interfaces 465, 466. The interface 465 is coupled to the communications bus 440 to provide bidirectional communications with the ONT device 450 external from the BBU 410. The interface 465 may be a parallel electrical, serial electrical or optical interface used to receive a status request signal 470 and provide information responsive thereto with another device 480 at the BBU other than the device 450 receiving backup power from the BBU 410. As shown in FIG. 4B, the interface 465 may also be a wireless interface used to receive the status request signal 470 and provide information responsive thereto with another device 480 via an Internet 467. The device 480 may be a telephone or any other physical or logical medium that a technician 475 may use to send the status request signal 470 to the BBU 410 or receive information from there. The interface 465 may also receive the status request signal 470 and provide information responsive thereto with the ONT 450.

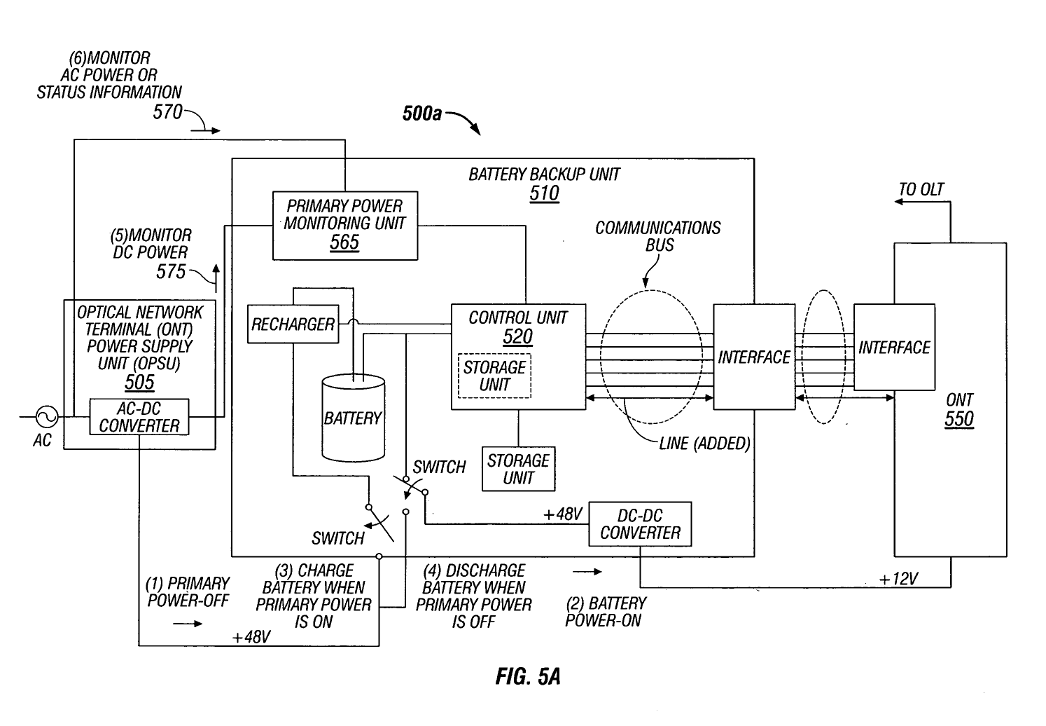

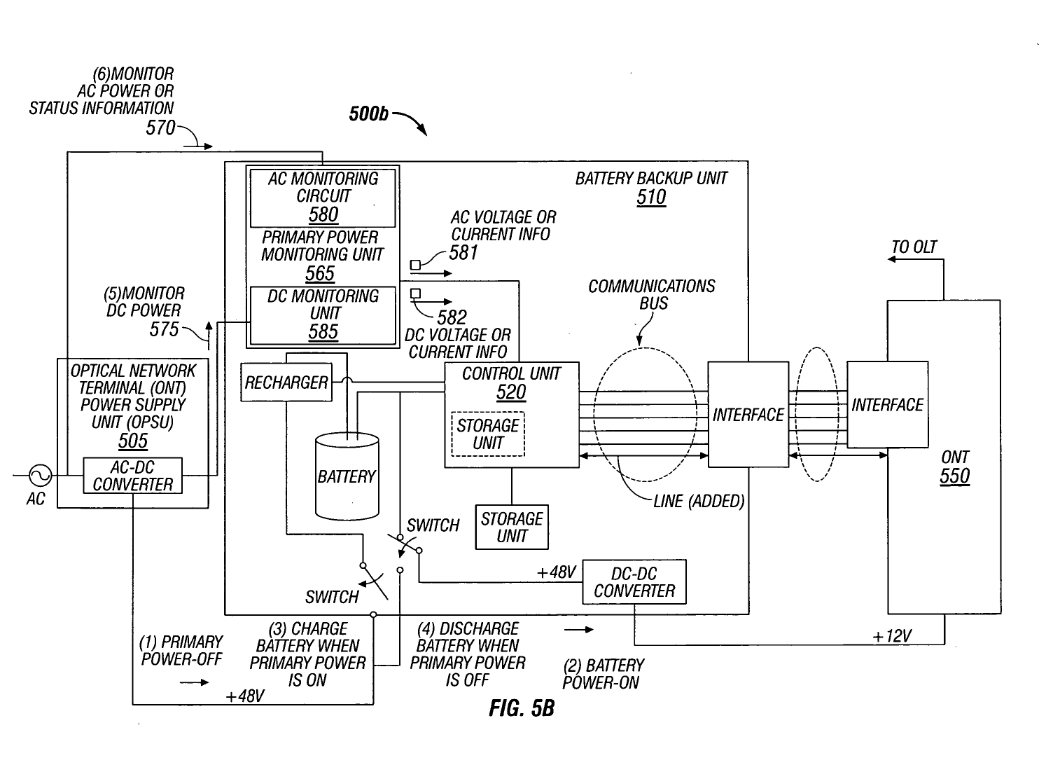

FIGS. 5A and 5B are block diagrams of Battery Backup Units (BBUs) 500a, 500b in accordance with yet other example embodiments of the invention. FIGS. 5A and 5B are similar to FIGS. 4A and 4B, but have additional components. For example, a BBU 510 may include a primary power monitoring unit 565 coupled to a primary power source (e.g., OPSU 505) to monitor power or status information of the primary power source (e.g., OPSU 505). As illustrated in FIGS. 4A and 4B, there may be no “failed BBU alarms.” By monitoring the BBU 510 input voltage 575, information can be ascertained about the state of the OPSU 505. This information can provide operational information about the OPSU 505. For example, if the input voltage 575 is lower than a technical specification requirement, a technician may infer that there is an issue with either the OPSU 505 or wirings between the OPSU 505 and the BBU 510. The BBU 510 may also monitor a status information such as the temperature and charging voltage to verify proper thermal compensation for a charging circuit (not shown). Moreover, the primary power monitoring unit 565 may also identify commercial power issues by monitoring the AC power 570.

As shown in FIG. 5B, the primary power monitoring unit 565 may include an AC monitoring circuit 580 to monitor the AC input voltage or current 581 and provide information to an ONT 550 via a control unit 520 about the AC input voltage or current 581. The primary power monitoring unit 565 may also include a DC monitoring circuit 585 to monitor the DC input voltage or current 582 and provide information to the ONT 550 via the control unit 520 about the DC input voltage or current 582. The AC input voltage or current 581 may be useful for identifying commercial power issues. The DC input voltage or current 582 may provide operational information about the OPSU 505.

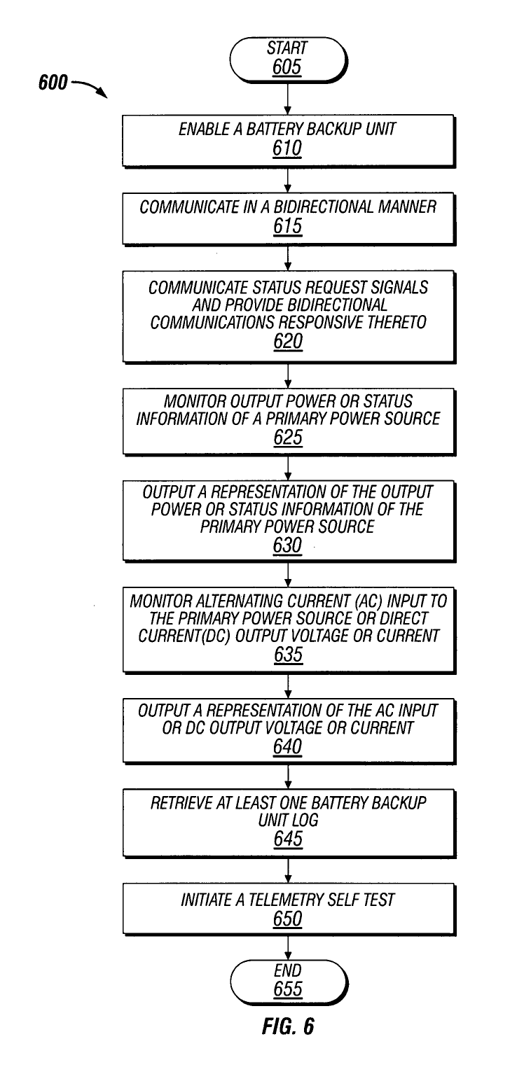

FIG. 6 is a flow diagram 600 performed in accordance with another example embodiment of the invention. The flow diagram starts (605), and a battery backup unit is enabled (610) in an event of a loss of primary power to an external device, such as an ONT. The primary power may be, for example, a power connection to a source (e.g., a wall outlet) providing power in the form of alternating current supplied to the external device by a commercial power company. The battery backup unit communicates in a bidirectional manner with the device external from the battery backup unit to receive status request signals and provide information responsive thereto about the battery backup unit, including information about at least one battery (615). The BBU may also communicate the status request signals and provide bidirectional communications responsive thereto with another device at the BBU other than the device receiving battery power from the BBU (620). The BBU may monitor output power or status information of a primary power source (625) and then outputting a representation of the output power or status information of the primary power source to the device external from the battery backup unit (630). The output power or status information may include monitoring alternating current (AC) input to the primary power source or direct current (DC) output voltage or current (635) and outputting a representation of the AC input or DC output voltage or current (640). The bidirectional communications between the battery backup unit and the device external from the battery backup unit includes retrieving at least one battery backup unit log (645). The bidirectional communications between the battery backup unit and the device external from the battery backup unit may also include initiating a telemetry self test (650) before ending (655).

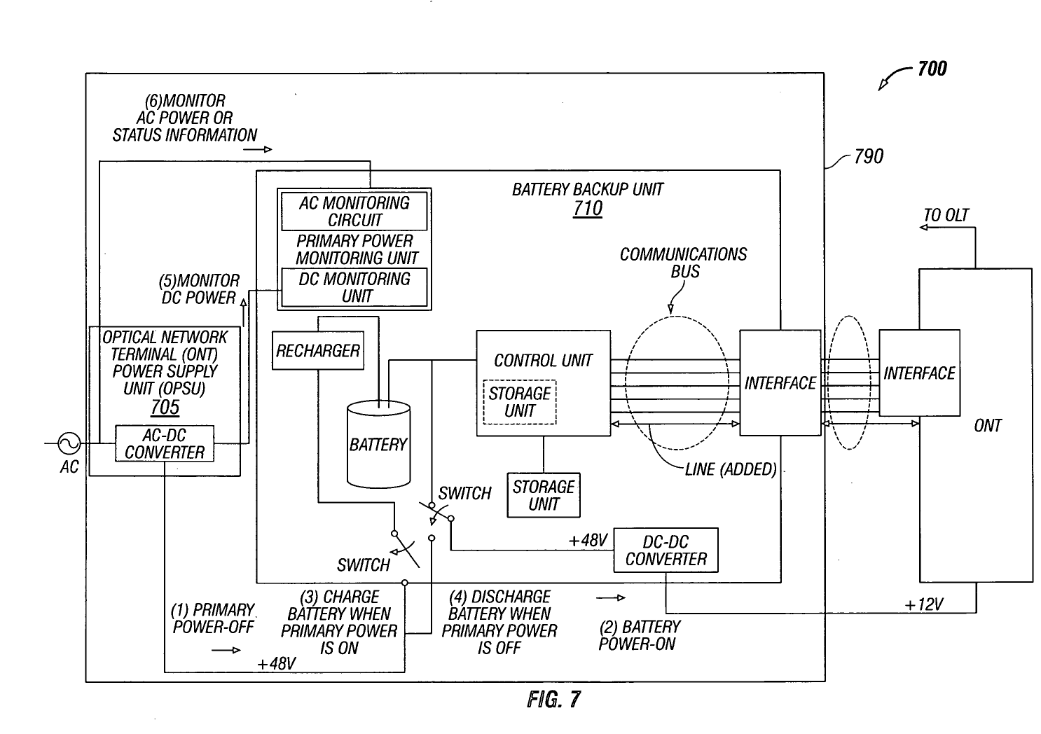

FIG. 7 is a block diagram of an Integrated Power Supply Unit (IPSU) 700 in accordance with yet another example embodiment of the invention. The IPSU 790 includes a Battery Backup Unit (BBU) 710 and Optical Network Terminal (ONT) Power Supply Unit (OPSU) 705. The OPSU 705 and the BBU 710 operations may be integrated into a single component, such as the IPSU 700. The functions may be, for example, performing real-time troubleshooting, downloading software upgrades, retrieving a battery backup unit log, and initiating a telemetry self test. The OPSU 705 may be removable from the IPSU 790. The IPSU may combine the OPSU 705 and the BBU 710 into a single package.

While this invention has been particularly shown and described with references to example embodiments thereof, it will be understood by those skilled in the art that various changes in form and details may be made therein without departing from the scope of the invention encompassed by the appended claims.

It should be understood that any of the above-described flow diagrams of FIGS. 3 and 6 or underlying methods used to implement aspects related to the networks of FIGS. 1, 2A, 2B, 4A, 4B, 5A, 5B, and 7 may be implemented in the form of hardware, firmware, software or any combination thereof. If implemented in software, the software may be in any suitable form of software that can be stored on any form of machine-readable medium (e.g., CD-ROM, floppy disk, tape, random access memory (RAM), read-only memory (ROM), optical disk, magnetic disk, FLASH memory, system memory, and hard drive), and loaded and executed by at least one general purpose or application specific processor. The software may be downloaded to nodes in a network via any form of network link including wired, wireless, or optical links, and via any form of communications protocol.

It should be further understood that the flow diagrams of FIGS. 3 and 6 are merely example embodiments of the invention, and other configurations, arrangements, additional blocks, fewer blocks, and so forth are possible in other embodiments. For example, the techniques illustrated in these figures may be performed sequentially, in parallel or in an order other than that which is described. In addition, it should be appreciate that not all of the techniques described are required to be performed, that additional techniques may be added, and that some of the illustrated techniques may be substituted with other techniques.

It should be further understood that the PON can be other network types, and the ONT can be any form of network node in a network employing a power backup unit, which may be a battery backup unit or other power storage device (e.g., capacitor) backup unit or self-generating power device, such as a solar panel or fuel cell.

What is claimed is:

1. A system in an optical network for monitoring a battery backup unit comprising:
an Optical Network Terminal (ONT) including an ONT processor unit configured to receive backup power from a battery backup unit with at least one battery in response to a loss of primary power; and
a control unit coupled to the at least one battery and a bidirectional bus, the control unit configured to communicate in a bidirectional manner with the ONT processor unit also coupled to the bidirectional communications bus to provide information about the battery backup unit, including information about the at least one battery.

2. The system of claim 1 wherein the control unit coupled to the bidirectional communications bus includes at least one line coupled to the control unit to receive a status request signals and provide bidirectional communications responsive thereto with the ONT processor unit in addition to bidirectional communications via the bidirectional communications bus.

3. The system of claim 1 wherein the information about the battery backup unit includes temperature, current, voltage, or at least one diagnostic test log.

4. The system of claim 3 wherein the at least one diagnostic test log includes at least one battery test log.

5. The system of claim 1 further comprising a primary power monitoring unit coupled to a primary power source to monitor power or status information of the primary power source.

6. The system of claim 5 wherein the primary power monitoring unit includes an alternating current (AC) monitoring circuit to monitor AC input voltage or current and provide information to the ONT processor unit about the AC input voltage or current.

7. The system of claim 5 wherein the primary power monitoring unit includes a direct current (DC) monitoring circuit to monitor DC output voltage or current and provide information to the ONT processor unit about the DC output voltage or current.

8. The system of claim 1 wherein the control unit is further configured to initiate a telemetry self test via the bidirectional communications bus.

9. The system of claim 1 further including at least one interface port coupled to the control unit, the at least one interface port is configured to download software to the battery backup unit via the bidirectional communications bus.

10. A battery backup unit comprising:
at least one battery;
a bidirectional communications bus; and
a control unit coupled to the at least one battery and the bidirectional communications bus, the control unit configured to communicate in a bidirectional manner with a device external from the battery backup unit also coupled to the bidirectional communications bus to receive status request signals and provide information responsive thereto about the battery backup unit, including information about the at least one battery.

11. The battery backup unit according to claim 10 wherein the device external from the battery backup unit is an Optical Network Terminal (ONT).

12. The battery backup unit according to claim 10 wherein the information about the battery backup unit includes temperature, current, voltage, or at least one diagnostic test log.

13. The battery backup unit according to claim 12 wherein the at least one diagnostic test log includes at least one battery test log.

14. The battery backup unit according to claim 10 further comprising a battery recharger configured to recharge the at least one battery.

15. The battery backup unit according to claim 10 wherein the control unit coupled to the bidirectional communications bus includes at least one line coupled to the control unit to receive the status request signals and provide bidirectional communications responsive thereto with the device external from the battery backup unit in addition to bidirectional communications via the bidirectional communications bus.

16. The battery backup unit according to claim 10 wherein the control unit is further configured to initiate a telemetry self test via the bidirectional communications bus.

17. The battery backup unit according to claim 10 further comprising at least one interface port coupled to the communications bus to provide bidirectional communications with the device external from the battery backup unit.

18. The battery backup unit according to claim 17 wherein the at least one interface port is configured to download software to the battery backup unit via the bidirectional communications bus.

19. The battery backup unit according to claim 17 wherein the at least one interface port is a parallel, serial, or wireless interface configured to receive the status request signals and provide information responsive thereto with another device at the battery backup unit other than the device configured to receive backup power from the battery backup unit.

20. The battery backup unit according to claim 10 further comprising a primary power monitoring unit coupled to a primary power source to monitor power or status information of the primary power source.

21. The battery backup unit according to claim 20 wherein the primary power monitoring unit includes an alternating current (AC) monitoring circuit to monitor AC input voltage or current and provide information to the device external from the battery backup unit about the AC input voltage or current.

22. The battery backup unit according to claim 20 wherein the primary power monitoring unit includes a direct current (DC) monitoring circuit to monitor DC output voltage or current and provide information to the device external from the battery backup unit about the DC input voltage or current.

23. The battery backup unit according to claim 20 wherein the primary power source is an Optical Network Terminal (ONT) Power Supply Unit (OPSU).

24. A method for monitoring a battery backup unit with at least one battery, comprising:
enabling the battery backup unit; and
communicating in a bidirectional manner between the battery backup unit and a device external from the battery backup unit to receive status request signals and provide information responsive thereto about the battery backup unit, including information about the at least one battery.

25. The method of claim 24 further comprising communicating status request signals and providing bidirectional communications responsive thereto with another device at the battery backup unit other than the device receiving battery power from the battery backup unit.

26. The method according to claim 24 further comprising:
monitoring output power or status information of a primary power source; and
outputting the output power or status information of the primary power source to the device external from the battery backup unit.

27. The method according to claim 24 wherein monitoring the power or status information of the primary power source includes:
monitoring alternating current (AC) input to the primary power source or direct current (DC) output voltage or current; and
outputting the AC input or DC output voltage or current.

28. The method according to claim 24 wherein communicating in the bidirectional manner between the battery backup unit and the device external from the battery backup unit includes retrieving at least one battery backup unit log.

29. The method according to claim 24 wherein communicating in the bidirectional manner between the battery backup unit and the device external from the battery backup unit includes initiating a telemetry self test.
